(19) United States
(12) Patent Application Publication
(10) Pub. No.: US 2018/0367096 A1
(43) Pub. Date: Dec. 20, 2018

(54) MOBILE SOLAR POWER SOURCE AND LIGHTING TOWER

(71) Applicant: Judd McCormack, Auroria, IL (US)

(72) Inventor: Judd McCormack, Auroria, IL (US)

(21) Appl. No.: 15/842,401

(22) Filed: Dec. 14, 2017

Related U.S. Application Data
(63) Continuation-in-part of application No. 15/626,606, filed on Jun. 19, 2017.

(51) Int. Cl. H02S 40/38; H02J 7/35; H02J 7/00; H02S 20/30; F21L 4/08; G09F 13/00

(52) U.S. Cl. CPC H02S 40/38; H02J 7/35; G09F 13/00; H02S 20/30; F21L 4/08; H02J 7/0021

(57) ABSTRACT

A mobile solar power source is disclosed and claimed. The mobile solar power source comprises a trailer mounted housing that includes three solar panels; the first solar panel is mounted on the front of the base housing, the second solar panel is coupled to the left side of the first solar panel by a piano hinge, and the third solar panel is coupled to the right side of the first solar panel by a second piano hinge. A pair of rotatable braces hold the second and third solar panels in place.

### CROSS REFERENCE TO RELATED APPLICATIONS

This application claims the benefit and priority of U.S. patent application Ser. No. 15/626,606, entitled “SYSTEM AND APPARATUS FOR RELIABLY POWERING A SIGN USING SOLAR POWER,” filed Jun. 19, 2017, which is hereby incorporated by reference in its entirety.

### FIELD OF THE DISCLOSURE

The present disclosure concerns providing a mobile system and apparatus for providing solar power to locations that do not have convenient access to utility power. The present disclosure further concerns providing a mobile solar powered lighting platform.

### DESCRIPTION OF BACKGROUND

Many venues are not suitable for outdoor activities due to a lack of power. Diesel based generators are well known, and can be used in certain circumstances, but are known to generate large amounts of noise and pollution. In addition, diesel fuel is highly flammable, and dangerous to transport. However, solar power is a well-accepted mostly safe source of power. In addition, certain mobile solar power sources are known. However, they tend to suffer from certain disadvantages.

For example, a number of mobile solar powered lighting towers are known in the art. Due to the power requirements of the light sources that were used, the prior art mobile power sources required large bulky constructs. In addition, solar cells are often fragile, and easily broken, and prior art solutions suffered from significant durability concerns.

Accordingly, there is a need for a compact mobile solar power solution with a high degree of durability.

Commercial signs are a well-known method by which businesses advertise their services. For example, many businesses will have a sign located on their premises that advertises the name of the business, the hours of the businesses, prices, and other information pertinent to the business's customers. Past commercial signs have relied on standard electrical service for power. In particular, when a commercial sign is generally installed, a power line must be run to the sign. Running a power line is expensive; in cases where a sign is located in an area without easy access to electrical service, the cost of installing electrical service can exceed that of the sign.

Solar cells are also well known, and have been used to power commercial signs. The advantage of solar powered signs is that in many cases, the sign can be entirely powered by a solar array coupled to batteries. During the day, the solar array charges the batteries. At night, the batteries power the sign. This allows for the advantages of a commercial sign without requiring electrical service. However, prior art solar powered signs have one major disadvantage over commercial signs that operate using electrical service, which is that they are far less reliable. In particular, while proper sizing of the battery pack and solar array based on typical and worst-case sunlight conditions to meet the requirements of a particular sign can guarantee sufficient power, the infrastructure typically used in solar powered signs does not provide a backup if many vulnerable components fail. For example, most solar powered signs rely on charge controllers; if the charge controller fails, then the entire circuit fails.

Accordingly, there is a need for a reliable solar power system, especially in connection with solar powered commercial signs.

### Objects of the Disclosed System, Method, and Apparatus

Accordingly, it is an object of the disclosure to provide a reliable power infrastructure for use with a solar power device.

Another object of the disclosure is to provide a reliable power infrastructure for use with a solar powered commercial sign.

Another object of the disclosure is to provide a reliable power infrastructure for use with a solar powered commercial sign that utilizes redundant circuitry to ensure reliability.

Another object of the disclosure is to provide a reliable power infrastructure for use with a solar powered commercial sign that utilizes a logic board to switch between redundant components.

Another object of the disclosure is to provide a reliable power infrastructure for use with a solar powered commercial sign that utilizes a logic board to switch between redundant charge controllers.

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

Generally speaking, pursuant to the various embodiments, the present disclosure provides a mobile solar power source. The disclosed mobile solar power source comprises a trailer having a suspension with wheels. Disposed on the trailer is a base housing that includes a front wall, a rear wall, a first side wall, a second side wall, a floor and a roof. The various sides, floor and roof define an interior of the base housing. Mounted on the exterior of the front wall is a solar panel that comprises a plurality of solar cells. A second solar panel is coupled to the left side of the first solar panel using a hinge, such as, for example, a piano hinge. The second solar panel has a notch attached to or integrally formed with its top surface. A third solar panel is coupled to the right side of the first solar panel by a second piano hinge, and also has a notch attached to or integrally formed into its top surface. The solar panels are arranged so that when they are opened, they face toward the front of the mobile solar power source as well as somewhat upwards. When closed, the solar panels are not visible; rather they are enclosed by the exterior surface of the second and third solar panels.

A battery unit is stored within the base housing. The battery unit will generally comprise a first battery bank and a second battery bank. A control unit is coupled to the solar panels. The control unit includes a first charge controller and a second charge controller. The first charge controller is coupled to the first battery bank and the second charge controller is coupled to the second battery bank. In addition, the control unit includes a logic board to determine which charge controller and battery bank are active. In addition, the mobile solar power source includes a first brace coupled to the left side of the base housing and a second brace coupled to the right side of the base housing. The first brace holds the second solar panel in place by sliding into the notch on top of the second solar panel, and the second brace holds the third solar panel in place by sliding into the notch on top of the third solar panel.

In further embodiments of the disclosed mobile solar power source a first cable can couple the second solar panel to the control unit as well as a second cable that couples the third solar panel to the control unit. In addition, a first pin can also be supplied and used couple the first brace to the slot on top of the second panel. In addition, a wire can be used to couple the first pin to the brace on the left side of the mobile solar power source.

In addition, in a further preferred embodiment, a channel is formed in the exterior of the roof of the base housing. A mast is rotatably coupled to the mobile solar power source and protrudes from the channel. The mast comprises a plurality of telescoping sections, with each successive section being disposed within the previous section. Atop the mast is a lighting module with at least one lamp that can be, for example, an LED lamp. An extending unit is disposed at the back of the mobile solar power source that is used to extend mast.

The extending unit can comprise a rod that can traverse vertically in relation to a guide. A winch can cause the rod to move up and down. A lifter is attached to or integrated with the rod, and coupled to the mast. As a user operates the winch, the rod moves up and down the lifter moves with and causes the mast to extend or detract. The winch can, in one embodiment, comprise a spindle coupled to a first gear and a second gear coupled to a handle. The winch can further be coupled to the rod by a cable that is routed through a pulley to a hitch on the rod. Finally, the lifter can have a notch within it that is adapted to couple with a pin that is placed through an aperture in a section of the mast.

The disclosed solar powered sign system includes an electric light and a battery unit. The battery unit comprises a first battery bank and a second battery bank. The battery unit generally provides power to the electric sign. A solar array produces electric power when sufficient light is present. The solar array is coupled to a control unit. The control unit includes a first charge controller coupled to the first battery bank and a second charge controller coupled to the second battery bank. The control unit also includes a logic board that is coupled to the first charge controller and the second charge controller. The logic board monitors the operational state of the first charge controller and the operational state of the second charge controller. When the operational state of the first charge controller indicates that the battery bank to which it is coupled has a greater charge reserve, the first charge controller can be coupled to a power output of the logic board. On the other hand, when the operational state of the second charge controller indicates that the battery bank to which it is coupled has a greater charge reserve, the second charge controller can be coupled to a power output of the logic board.

In additional embodiments, the system can further comprise a user programmable timer coupled to the logic board. The user programmable timer is configured by a user to produce an active signal during a certain time period, which can repeat daily, or on some other basis. Only when the active signal is present is one of the charge controllers coupled to a power output of the logic board, and from there, to the electric sign.

Similarly, the system can further comprise a photocell coupled to the logic board. The photocell produces an active signal when ambient light falls below a certain level; typically, when there is no longer enough sunlight to power the electric sign and charge the battery unit. Only when the active signal is present is one of the charge controllers coupled to a power output of the logic board, and from there, to the electric sign.

Further, the logic board can comprise a first relay and a second relay. An input contact of the first relay is coupled to a power output of the first charge controller. An output contact of the first relay is coupled to an input contact of the second relay, and an output contact of the second relay is coupled to a power output of the logic board.

The logic board can also comprise a third relay and a fourth relay. An input contact of the third relay is coupled to a power output of the second charge controller. An output contact of the third relay is coupled to an input contact of the fourth relay. An output contact of the fourth relay is coupled to a power output of the logic board.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a perspective view of a reliable solar powered sign system constructed in accordance with this disclosure.

FIG. 2 is a block diagram of a reliable solar powered sign system constructed in accordance with this disclosure.

FIG. 3 is a listing logic used to activate an electric sign.

FIG. 4 is detailed schematic view of a logic board for use with a reliable solar powered sign system constructed in accordance with this disclosure.

FIG. 5 is an alternative block diagram of a reliable solar power sign system constructed in accordance with this disclosure.

FIG. 6 is a side perspective view of a mobile solar power source constructed in accordance with this disclosure.

FIG. 7 is a side perspective view of a mobile solar powered lighting tower constructed in accordance with this disclosure.

FIG. 8 is a front perspective view of a mobile solar powered lighting tower constructed in accordance with this disclosure.

FIG. 9 is a rear perspective view of a mobile solar powered lighting tower constructed in accordance with this disclosure.

FIG. 10 is a rear perspective view of a mobile solar powered lighting tower constructed in accordance with this disclosure.

FIG. 11 is a closeup view of a lighting tower and extending unit constructed in accordance with this disclosure.

FIG. 12 is a block diagram of a mobile solar power source constructed in accordance with this disclosure.

A person of ordinary skills in the art will appreciate that elements of the figures above are illustrated for simplicity and clarity, and are not necessarily drawn to scale. The dimensions of some elements in the figures may have been exaggerated relative to other elements to help understanding of the present teachings. Furthermore, a particular order in which certain elements, parts, components, modules, steps, actions, events and/or processes are described or illustrated may not be actually required. A person of ordinary skills in the art will appreciate that, for the purpose of simplicity and clarity of illustration, some commonly known and well-understood elements that are useful and/or necessary in a commercially feasible embodiment may not be depicted in order to provide a clear view of various embodiments in accordance with the present teachings.

### DETAILED DESCRIPTION

The Reliable Solar Power Control System

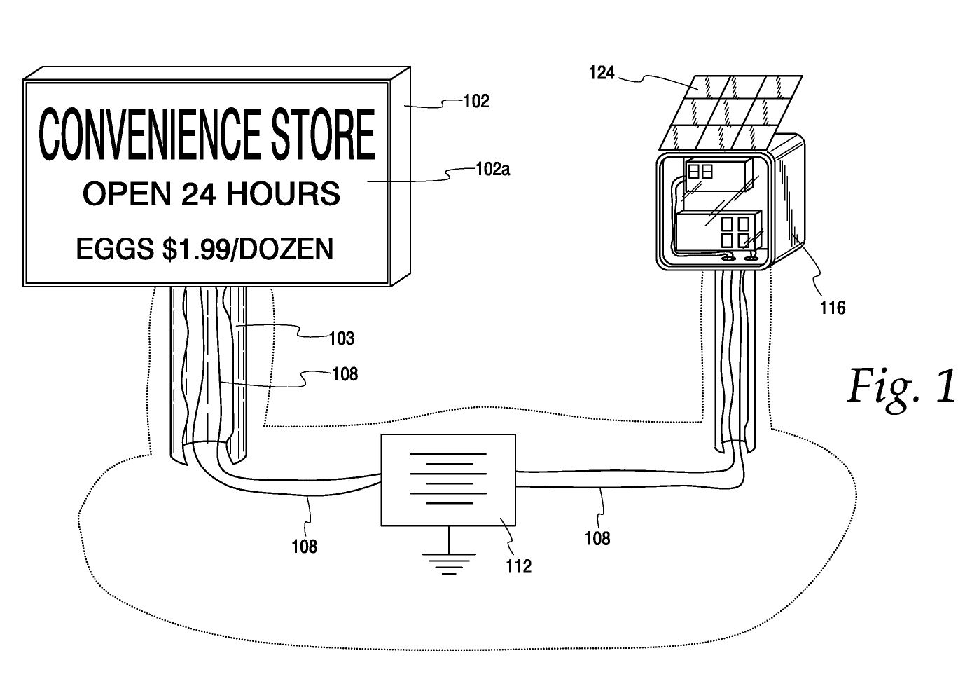

Turning to the Figures and to FIG. 1 in particular, a reliable solar powered sign system constructed in accordance with this disclosure is depicted and generally indicated at 100. The illustrated system 100 includes an electric powered sign 102 of the type that is well known in the art. In particular, the electric powered sign 102 includes a display 102a that allows the electric powered sign 102 to indicate basic information in a manner that is visible anytime of the day; i.e., using lights, a backlit LCD, etc. The electric powered sign 102 is powered and controlled by a power-control cord bundle 108, which is shown routed through a pole 103, although other routing mechanisms can be used. As depicted, the power-control cord bundle 108 is routed into and through a battery unit 112. The battery unit 112 includes an array of batteries, which could be, for example, lead-acid batteries, as well as associated support circuitry; i.e., connectors, cabling, etc., as is well known in the art and not discussed herein. As set forth herein, there are two separate battery units, 112a and 112b, to provide complete redundancy.

The disclosed reliable solar powered sign system 100 further includes a control unit 116. The control unit 116 includes a logic board, charging units, and other equipment as explained further herein. The control unit 116 generally controls the operation of the sign 102 and charges the battery unit 112 when conditions permit. Finally, the disclosed reliable solar powered sign system 100 includes a solar array 124. The solar array 124 should be sized to produce sufficient power to operate the sign 102 during daytime hours and to provide sufficient additional charge to charge the batteries so that they can operate the sign 102 at night when solar power is not available. The solar array 124 comprises a plurality of solar cells, which can be any type of solar cell that is suitable, including, but not limited to, a multijunction cell, a single junction Gallium Arsenide cell, a Crystalline Silicon cell; a Thin-Film Technology cell, a Dye Sensitive cell, a Perovskite cell, an Organic cell, an Organic Tandem cell, a Quantum Dot cell, or other cells that are known in the art. In particular, as is well known in the art, solar cells generally convert sunlight into direct current electricity which is conditioned by charge controllers (explained below) within the control unit 116.

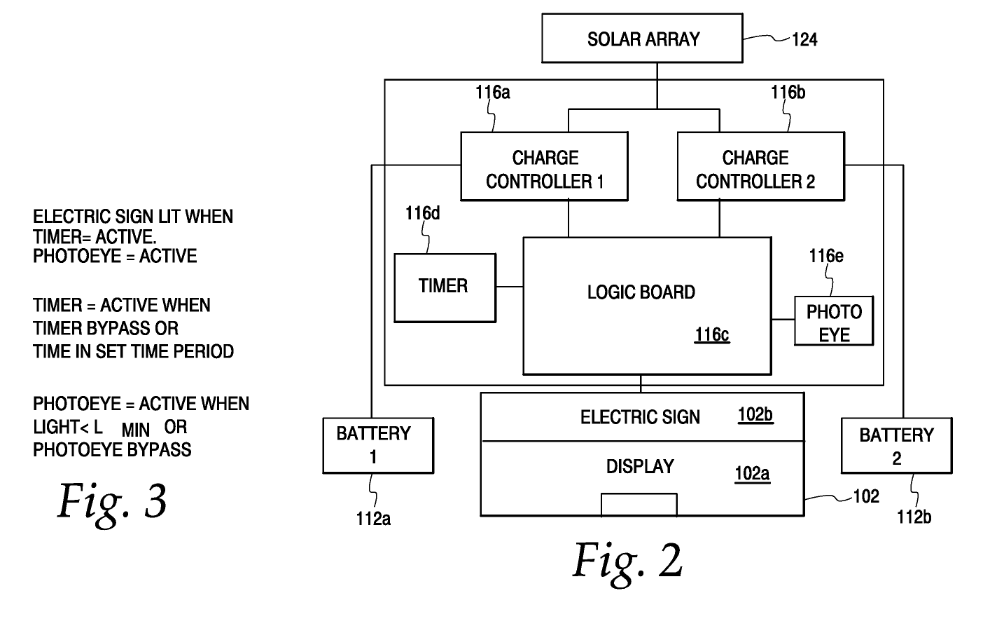

Turning to FIG. 2, a block diagram of the disclosed reliable solar powered sign system 100 of FIG. 1 is depicted with additional detail. In particular, the electric powered sign 102 further comprises a display 102a, which likely includes an integrated controller (not shown), along with a power module 102b. The electric powered sign 102 is powered by a battery unit 112, which comprises a first battery bank 112a and a second battery bank 112b. The battery banks 112a,b asized to allow the sign 112 to operate during the entire period that solar energy is not available to charge the battery unit 112 and power the sign 102.

The primary responsibility of the control unit 116 is to accept power from the solar array 124 and use that to charge the battery unit 112 and power the sign 102. As set forth below, the control unit 116 further comprises a first redundant charge controller 116a and a second redundant charge controller 116b. The first charge controller 116a is coupled to the first battery bank 112a, while the second charge controller 116b is coupled to the second battery bank 112b. Each charge controller 116a,b conditions power from the solar panel 124 (when available) so as to provide a stable DC power source for each battery bank 112a,b. The logic board 116c performs a number of critical functions as set forth herein. The most important function of the logic board 116c is to activate the sign 102 in accordance with the desires of a user. In particular, the logic board 116c is adapted to activate the electric sign 102 based on outputs from a timer 116d and a photoeye 116e. In particular, the electric sign 102 is activated if the timer 116d outputs active and the photoeye 116e outputs active. The timer 116d can output active under two circumstances. First, the timer 116d can be bypassed; i.e., the user can manually operate a switch on the logic board 116c or the the timer 116d to place it into bypass mode; i.e., where the output from the timer 116d always indicates active. Second, the timer 116d outputs active during a user configured time period, such as between 7 PM and 11 PM. The photoeye 116e also outputs active under two circumstances as well. First, as with the timer 116d, the photoeye 116e can also be put into bypass mode by the user operating a switch on the logic board 116c, and, while in bypass, the photoeye 116e will output active. Second, the photoeye 116e also outputs active when the ambient light level presented to the photoeye 116e falls below a certain level; typically, the level of light necessary for the solar array 124 to generate sufficient power to operate the sign 102 and charge the battery banks 112a,b. This logic is illustrated in FIG. 3.

As can be seen in FIG. 3, a user can configure the electric sign to operate 1) on a timer, such as from 5 PM until 10 PM every night, 2) when the level of ambient light falls below a certain level; i.e.; when it starts to get dark, or 3) a combination of the two, such as, for example, between 5 PM and 10 PM starting when the ambient light level indicates that twilight is starting. This allows the user additional control over previous systems, which generally only allowed the user to operate the electric sign based on a timer.

Returning to FIG. 2, the other function of the logic board 116c is to maintain power to the sign if one of the battery banks 112a,b, charge controllers 116a,b, or even part of the logic board fails. In particular, the logic board 116c includes logic to determine whenever a particular component has failed, and to bypass the failed component to ensure up time for the sign 102. To start, the logic board monitors the operation of the first charge controller 116a and the second charge controller 116b, and based on the operational state of each, determines which charge controller 116a,b is coupled to the electric sign 102. For example, if the battery bank 112a coupled to the first charge controller 116a has a remaining capacity of 80% and the battery bank 112b coupled to the second charge controller 116b has a remaining capacity of 60%, then the first charge controller 116a (and by extension the first battery bank 112a) will be coupled to the electric sign 102.

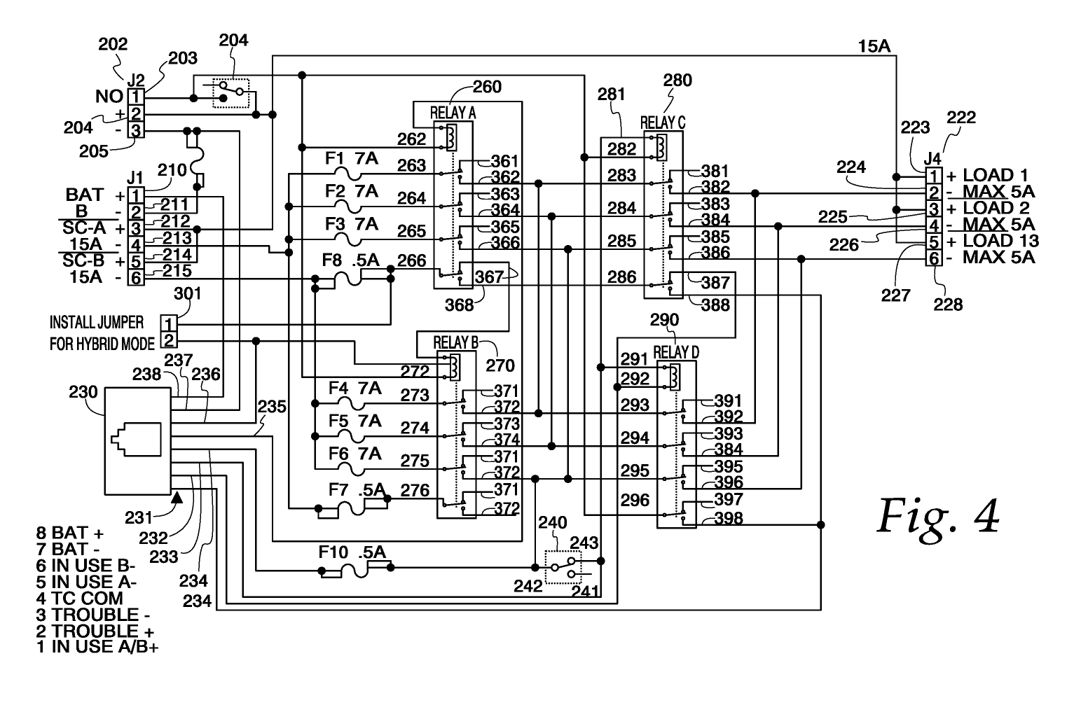

Turning to FIG. 4, a detailed schematic of one embodiment of the logic board 200 is depicted. It should be noted that this is merely one embodiment, and other embodiments could be used; for example, a microprocessor or microcontroller could be used. The logic board 200 can be constructed using any suitable technology. For example, a double-sided PC board could be used along with standard through hole components. Alternatively, the logic board could be constructed of a smaller four-layer PC board utilizing surface mount components. Finally, while the term logic board 200 is used throughout, this is equally applicable to a configuration that implements the functionality of the logic board 200 onto a single chip, or onto other components of the system.

The logic board 200 accepts inputs from a photocell connector 202 to which a light sensing photocell (also referred to herein as a photoeye) can be connected. The normally open (NO) terminal of the photocell connector 202 is coupled to a bypass switch 204. When the bypass switch 204 is thrown, the normally open terminal of the photocell connector is coupled the positive terminals 223, 225, 227 of the load connector 222.

An Ethernet connector 230 connects the logic board 200 to an external timer (not shown) using a CAT5 cable (not shown). The external timer is powered by an external battery bank (not shown), which is coupled to terminals 211 and 212 of six-terminal connector 210. In particular, the negative BAT B terminal 212 is connected to the negative terminal of the photocell connector 202 and to terminal 237 of the timer connector 230. The positive BAT B terminal 211 is connected to terminal 238 of the timer connector 230.

The logic board 200 also includes a six-terminal load connector 222. As drawn, there are three separate load hookups. The first load hookup comprises pins 223 and 224. The second load hookup comprises pins 225 and 226. The third load hookup comprises pins 227 and 228. In the disclosed embodiment all of the load hookups are turned on or off at the same time, although this is not a limitation of the disclosed reliable solar power system. In addition, a person of ordinary skill in the art would understand that any number of load hookups could be used as long as the appropriate components were selected.

Pin 234 of connector 230 is coupled to a user operated switch 240, which, when operated, allows the timer to control operation of the electric sign 102 as outlined herein.

Returning to connector 210 pins 213 and 214 are outputs from a first charge controller 116a. When active, the first charge controller 116a will output conditioned power for use in charging the main battery bank 112. Pin 213, the positive output of the first charge controller 116a, is connected to the positive terminals of all three load hookups; i.e., to pins 223, 225, and 227. Pin 215, the positive output of the second charge controller 116b, is also connected to the positive terminals of the three load hookups; i.e., pins 223, 225 and 227.

The main function of the logic board 200 is accomplished by four relays; 260, 270, 280 and 290, all of which are four pole double throw (4PDT). The positive terminals of relays 260, 270 and 280; i.e., pins 262, 272, 282; are connected to pin 203 of the photocell connector 202; i.e., the normally open contact of the photocell. The negative terminals of relay 290; i.e., pin 291 is also connected to the normally open contact of the photocell; i.e., pin 203.

The negative terminal 214 of the first charge controller 116a is connected to the inputs of three contacts of a first four pole double throw relay 260. In particular, the negative terminal 214 of the first charge controller 116a is connected to terminals 263, 264 and 265 of relay 260. The coil of relay 260 is operated by either the photocell or timer as explained herein. Pin 262, which is the positive of the coil of relay 260 is coupled to pin 203 of photocell connector 202.

Pin 261, which is the negative terminal of the coil of relay 260 is coupled to pin 235 of the timer connector 230. Pin 261 is also coupled to the third output of relay 270; i.e., pin 376. This is to prevent both charge controllers from being hooked to the output at the same time. When the coil of relay 260 is energized the outputs of relay 260; i.e., pins 362, 364 and 366 are all coupled to the negative terminal of the first charge controller 116a.

Similarly, the negative terminal 281 of the coil of relay 280 is coupled to the normally open terminal 243 of the timeclock bypass switch 240. When the bypass switch is activated, terminal 242 of the switch is connected to terminal 243, which allows the timer signal on pin 233 of the timer connector 230 to operate the coil of relay 280.

When the coils of relays 260 and 280 are pulled in, the negative terminal 214 of the first charge controller 116a is coupled through both relays to the negative terminals of the load hookups; i.e., to pins 224, 226, and 228. When the coil of relay 270 is energized, its outputs can also be coupled through the first three poles of relay 280.

The operation of relays 270 and 290 is similar to the operation of relays 260 and 280, but is directed to routing the output of second charge controller 116b to the load hookup connector 222. In particular, the negative terminal 216 of the second charge controller output is connected to the input of pole four of relay 260; i.e., terminal 266; as well as to the inputs of the first three poles of relay 270; i.e., to terminals 273, 274, and 275. The negative terminal 271 of the coil of relay 270 is connected to pin 236 of the timer connector 230. In addition, when jumper 301 is installed, the negative terminal 271 of the coil of relay 270 is connected to the negative terminal of the charge controller output 216. When the coil of relay 270 is energized the negative terminal of the second charge controller 116b is connected to the output of the first three poles of relay 270.

The positive terminal 292 of the coil of relay 290 is coupled to pin 232 of the timer connector 230. When the coil of relay 290 is energized, its inputs; namely the outputs of the first three poles of either relay 260 or 270, depending on which relays' are in the active state. Of course, it is impossible for the coils of both relays 260 and 270 to be energized at the same time; in particular, the output of the fourth pole 367 of relay 260 is coupled to the negative terminal 271 of the coil of relay 270. Similarly, the output of the fourth pole 377 of relay 270 is coupled to the negative terminal 261 of relay 260.

In addition, a similar technique is used to guarantee that the coils of relays 280 and 290 are not energized at the same time. In particular, the normally closed terminal 387 of the fourth pole of relay 280 is coupled to the positive terminal 292 of the coil of relay 290. Accordingly, whenever relay 280 is active; i.e., the normally open contact is energized, relay 290 will immediately open.

In summary, the operation of logic board 200 is as follows. Relays 260 and 270 are coupled to the battery banks through the charge controller. The battery bank with the greater capacity is selected as the active battery bank, and the appropriate relay is activated. Relay 280 is the main power output. As long as relay 280 is functional, the output of relay 260 or 270 is routed through the main power output. On the other hand, if relay 280 fails, and, for example, cannot open, then power will be routed through relay 290, which is the auxiliary relay. It should be also be noted none of the relays will be pulled in if the photoeye/timer logic indicates that the electric light should not be activated.

While the above system has been described in terms of a first battery bank 112a and a second battery bank 112b, the logic board described above could be used to switch between a battery bank and a utility electric line (which would have to be rectified and conditioned to DC).

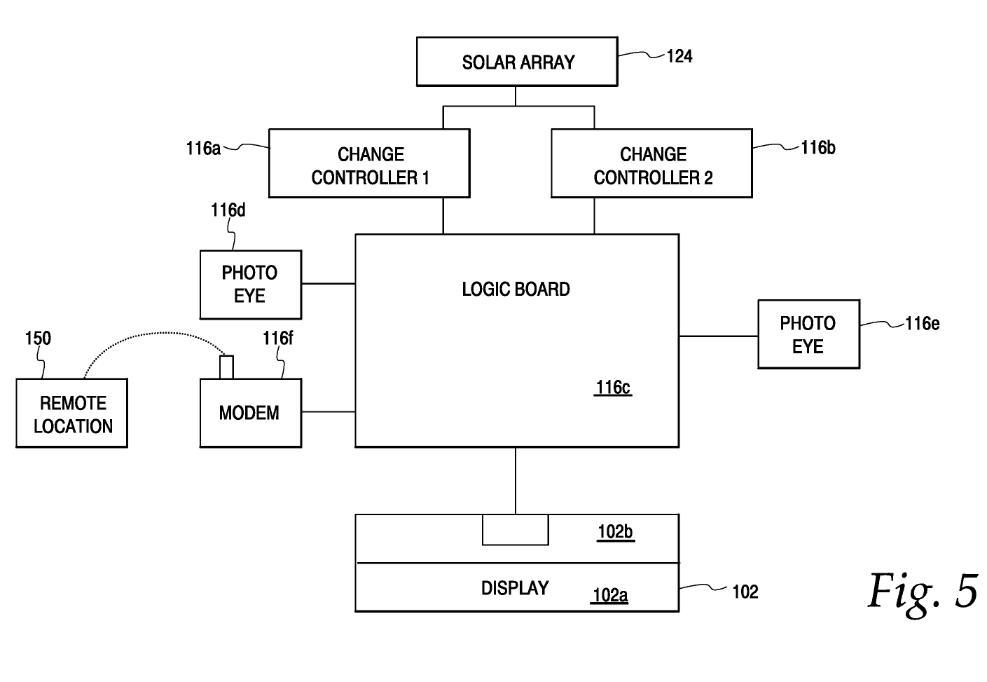

Turning to FIG. 5, an additional block diagram depicting an additional embodiment of a reliable solar power system is depicted. FIG. 5 is identical to FIG. 2 with the exception that a cellular modem 116f is also coupled to the logic board 116c. The cellular modem 116f is adapted to communicate status information about the sign to a different location, such as a monitoring server. For example, if the main power output relay described above fails, a message can be sent via the cellular modem 116f to a remote location 150.

The Mobile Solar Power Source and Mobile Solar Powered Light Tower

A number of mobile solar power sources are disclosed herein in various embodiments. The disclosed mobile solar power sources are adapted to provide a reliable power source without the emissions and noise that are associated with fossil fuels. Generally, the disclosed mobile solar power sources, in certain embodiments, comprise a housing unit, one or more solar panels that can be statically or rotatably attached to the housing, and one or more batteries contained within the housing. In certain embodiments, a mobile solar power source constructed in accordance with this disclosure can also include an extendable lighting tower that can include, for example, a lighting module with one more LED lights.

As described herein, each of the solar panels can comprise a plurality of solar cells. Each of the solar cells will generate a small amount of electricity when exposed to sunlight as is known in the art.

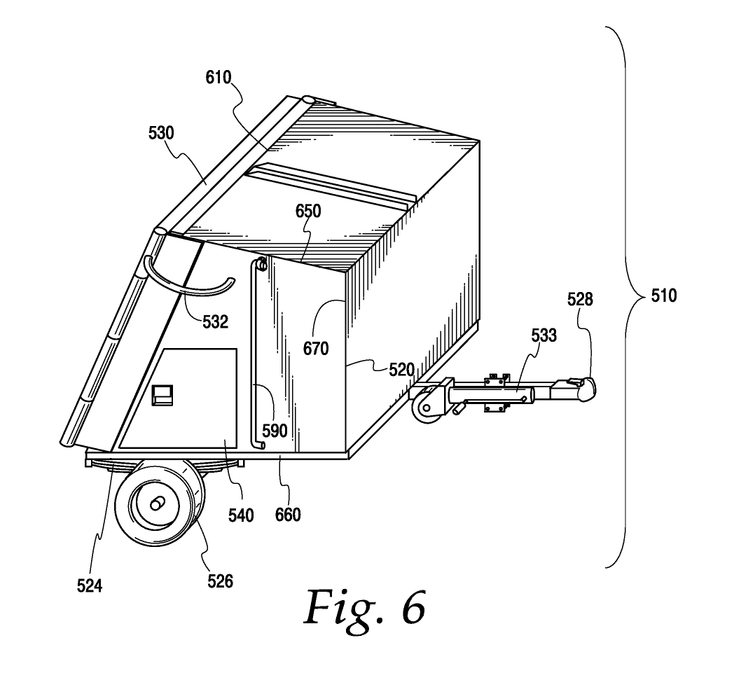

Turning to the Figures and to FIG. 6 in particular, a mobile solar power source 510 according to a particular embodiment is disclosed. The mobile solar power source 510 is depicted in its mobile or compact form, as explained herein. In particular, in the front perspective view depicted, the mobile solar power source 10 comprises a base housing unit 520, a set of stowed solar panels 530 that are connected to the base housing unit 520 by a charging wire 532. A user operable door is located on the exterior of the housing 520. In addition, a brace 590 is rotatably coupled to the exterior of the housing 520. The housing 520 sits atop a suspension 524 that includes a plurality of wheels 526 that are coupled via an axle (not shown). The suspension 524 includes any necessary components, such as, for example, axles, shocks, lights and other electrical components, stabilizing components, etc. A toe rod 528 is also coupled to the suspension 524, and is useful for allowing the mobile power source 510 to be transported by any vehicle equipped with a toe hitch. When the mobile power source 510 is transported to the desired location, a pair of stops 533a and 533b can be deployed to hold the unit upright when it is unhooked from the toe hitch.

The base housing unit 520 can include a plurality of walls, including a front wall 610, a back wall 620 and two opposing side walls, 630 and 640. The two opposing side walls, 630 and 640, are characterized as being interconnected by front wall 610 and back wall 620. The plurality of walls are also attached along their bottom edges by a floor 560 and the plurality of walls are also attached along their top edges by a roof 650. When combined, the plurality of walls, the roof 650 and the floor 660 form a single, coherent base housing unit 520 that can include one or more components, including, for example, active components, such as powered fans and passive, such as vents. Various components contained within the base housing unit 520 are discussed further herein.

The base housing unit 520 can be constructed of any material capable of providing sufficient strength and durability, although lightweight, easy to transport materials are advantageous. For example, stainless steel, aluminum, steel, other metals and alloys, strong plastics, fiberglass, composites, or other suitable materials can be used. In one embodiment, the base housing unit 520 is constructed of steel or aluminum.

On one side of the base housing unit 520 is a storage door 540 that, when opened, unveils a storage area. The storage area can store, for example, a set of expandable hazard cones that can be used to warn people away from the mobile solar power source 10, a set of chocks to hold the mobile solar power source 10 in place, or other equipment, such as, for example, extension cords, etc.

In addition, certain embodiments can include other equipment. In particular, many outdoor events require security, which can be improved by video monitoring. Accordingly, certain embodiments of the disclosed mobile solar power source can include, for example, a CCTV system. A typical CCTV system will include a camera, which can be analog or digital, and a recording medium, such as, for example, streaming magnetic tape, a hard drive, or non-volatile digital storage, such as a large amount of NVRAM or FLASH Memory.

In addition, in certain cases, it is advantageous to provide one or more 120 VAC outlets from the mobile power source. For example, external devices may need to be powered, and the 120 VAC (or some other voltage) outlet can accomplish that. To accomplish the same, the mobile power source will need to include an inverter and an output stage including a transfer that can convert the DC (from the batteries) to AC of the desired voltage, such as 120 VAC.

Similarly, the mobile solar power source 510 may be stored for long periods between deployments. During the periods that it is stored, the internal batteries are likely to lose their charge. Accordingly, the mobile solar power source 510 includes an external plug (not shown) to which an extension cord can be hooked. Internal to the mobile power source 510, within the base housing unit, is located a battery charger to convert the AC from the extension cord, which could be 120 VAC, 208 VAC, 220 VAC, 480 VAC, or any other common variant, to DC suitable to charging the batteries. For example, the battery charger may produce, for example, 14 VDC, 28 VDC or any other common variant. These additions allow a user to hook the battery charger up to an extension cord before deployment, and fully charge the batteries, guaranteeing a ready supply of power as soon as the mobile solar power source 510 is deployed.

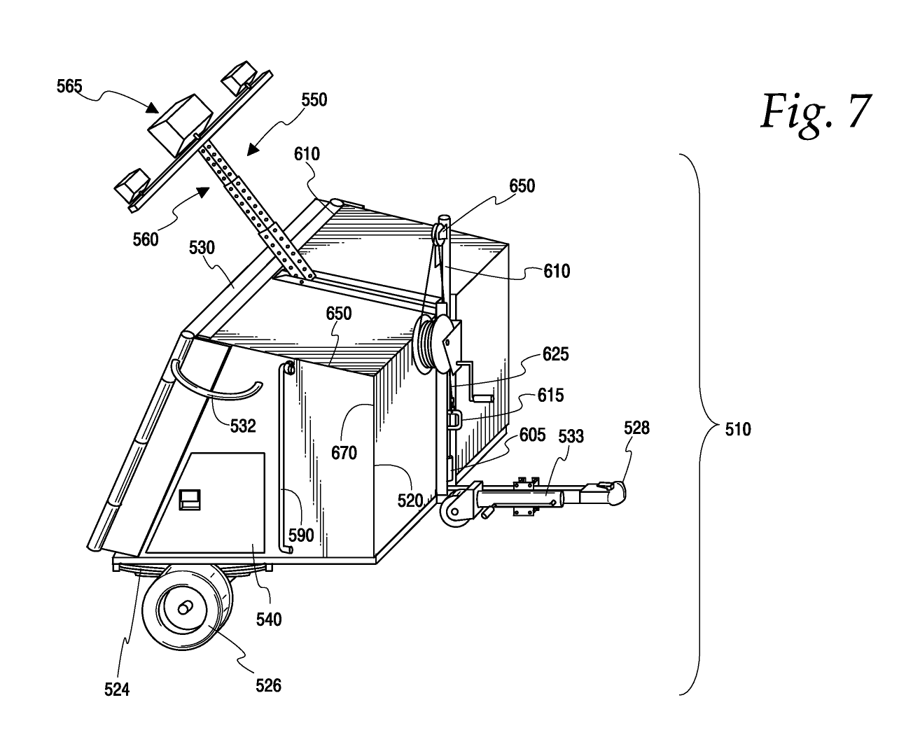

In certain embodiments, as illustrated in FIG. 7, the base housing unit 520 can include a telescoping lighting tower 550 as well as an extending unit 600. In the disclosed embodiment the lighting tower 550 is mounted rotatably within a channel 549 that is formed on the exterior of the roof 650 of the housing unit 520, so that it can rotate backwards and be deployed by the extending unit 600 as discussed herein. The lighting tower 550 comprises a mast 560 and a lighting module 565. The mast 560 is rotatably coupled to the base housing unit 520 as discussed herein. As depicted, the lighting module 565 comprises five LED lamps. However, a variable number of LED lamps or other types of lamps could be used. LED lamps are advantageous for their low power consumption for a given level of brightness. However, for extremely high brightness requirements, LED lamps may not be suitable, and other, less efficient lamps may be used. It should be noted that the type of lamp is not a limitation of this disclosure. The extending unit 600 is discussed in detail herein.

In the configuration illustrated in FIG. 7, the lighting tower 550 is positioned in its stowed position so that the mobile solar power source 510 can be safely transported without damage to the device and without danger to the lighting module 565, which, in an upright position, would have a greater risk of coming into contact with various objects and sustaining damage. In addition, the solar panels 530 are in a stowed configuration, so that the solar panels 530 are protected. In particular, the solar panels 530 have a reduced profile, and the side of each of the solar panels 530 that actually contains solar cells are not exposed to exterior contact. Rather, a protected side of one panel is directed toward the front of the mobile solar power source 510. The protected side of the panel can be made of, for example, steel, aluminum, or another suitable strong material. When the lighting tower 550 and solar panels 530 are stowed, the mobile solar power source 520 is compact, and can be stored in a minimal amount of space. For example, when compact at least two mobile solar power sources 520 can be stored within a standard tractor trailer.

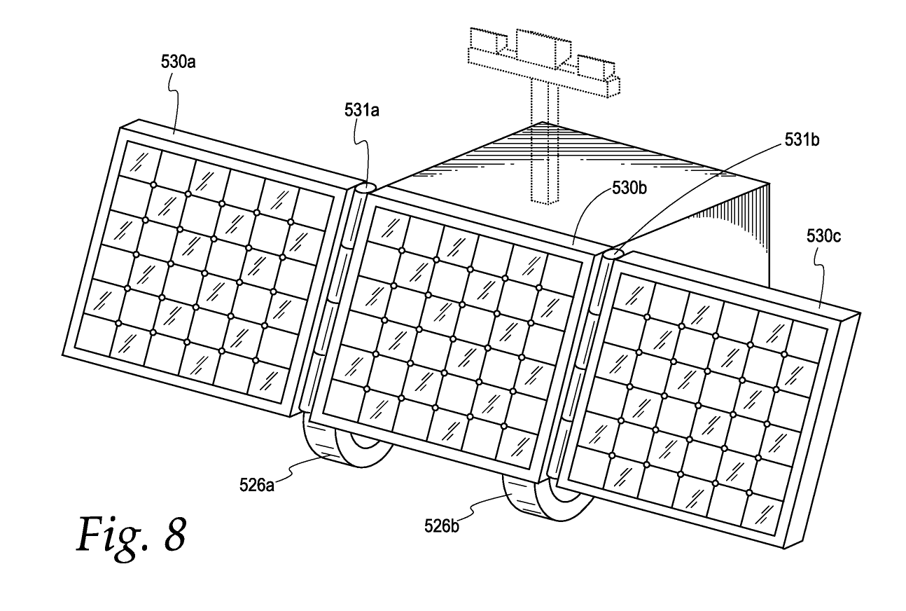

The mobile solar power source 510 is particularly beneficial because it can be easily transported to an outdoor area (or even an indoor area if necessary if the batteries are charged) to provide a mobile source of power. Once the mobile solar power source 510 is transported to the target location, the solar panels 530 can be deployed so that the solar panels 530 are illuminated by the sun. Turning to FIG. 8, the mobile solar power source 510 is depicted with the solar panels 530 in a deployed configuration. As depicted, there are three solar panels; in particular, panel 530a is rotatably coupled to the base housing unit 520 by hinge 531a and panel 530c is rotatably coupled to the base housing unit buy 520 by hinge 531b. Hinge 531a and hinge 531b can be, for example, a piano hinge. Finally, solar panel 530b is statically coupled to, or integrated within, the base housing unit 520.

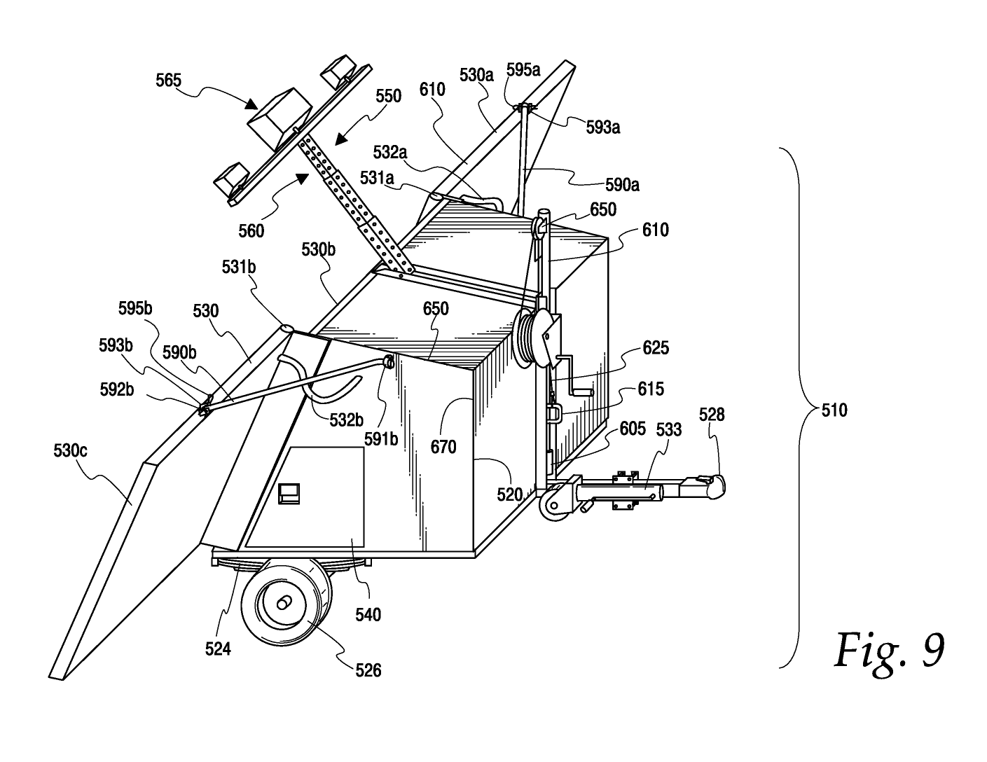

Turning to FIG. 9, an oblique perspective view of the disclosed mobile solar power source 510 is illustrated with the solar panels deployed. In particular, the brace 590b (and 590a) that holds the solar panel 530c (and 530a) in the deployed position is visualized. The brace 590b will typically be deployed in a downward position, with one end inserted into eyelet 592b. The brace 590b is rotatably affixed to the base housing 520 at a first end. In particular, the brace 590b is mounted to the base housing 520 by a rotating mount 591b. The rotating mount 591b can be any such mount that is well known in the prior art, such as, for example, a rotating flange. The eyelet 592b can be, for example, a standard steel eyelet 592b.

When the solar panel 530c is deployed, the brace 590b is rotated from the downward position to a latched position, so that it can brace the solar panel 530c. In particular, the brace 590b is rotated so that the end distal from the rotating mount 591b is affixed into a slotted receptacle 593b. The slotted receptacle 593b can be affixed to, or formed from, a top surface of the solar panel 530c. When the brace 590b is in the deployed (latched) position, the solar panel 530c is held firmly in place so that wind or other disturbances does not cause the panel 530c to open or close unexpectedly, thereby avoiding damage due to impact. When in place the brace 590b is held in place by a pin 595b that is held in place by a wire 594b, that is in turn connected to the brace 590b.

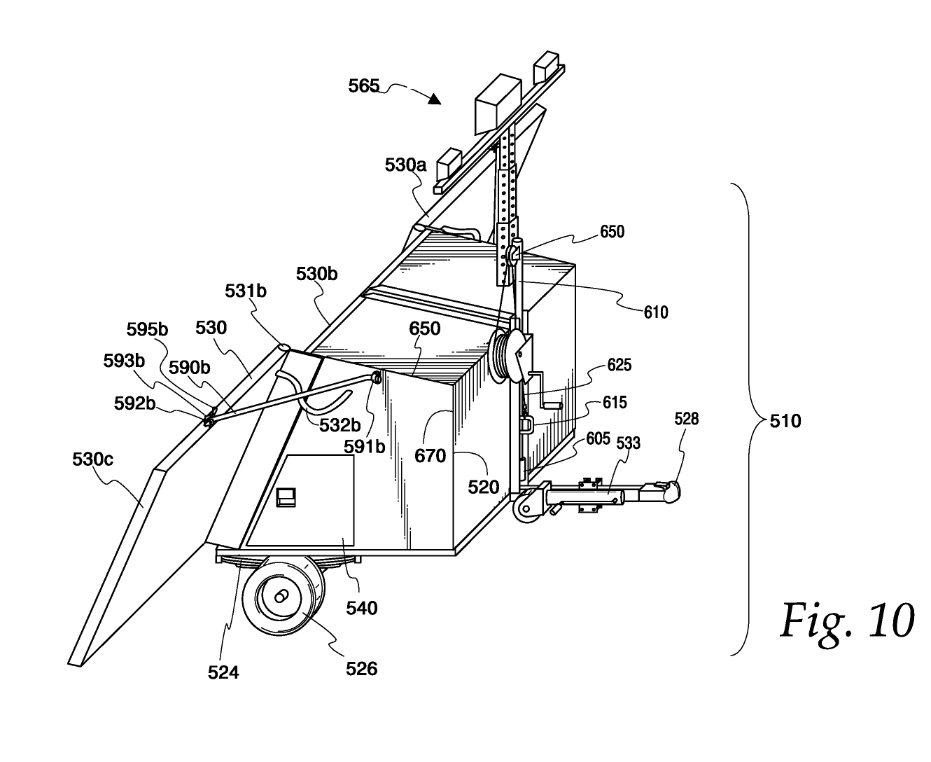

As stated earlier, and as is illustrated in FIG. 10, certain embodiments of the disclosed mobile solar power source 510 incorporate a lighting tower 550 that can be raised using an extending unit 600. The lighting tower comprises a mast 560 and a lighting module 565. The mast 560 comprises a telescoping rod with a number of sections as set forth herein. As is known in the art, the sections of the rod include through holes in all sides so that a pin or bolt can be inserted to hold the telescoping rod at a given extension. The mast is coupled to the interior of the base housing 520 in a rotating manner (not shown). When in compact or transport mode, the mast 560 can be held in place by a pin 566 held in place by a wire 567.

When the lighting tower 550 is to be extended, it is rotated toward the extending unit 600. The extending unit 600 comprises a hoist that includes a rod 610. The rod can move vertically within a guide 605. A hitch 615 is coupled to a bottom end of the rod 610, and, as explained herein, is used to raise and lower the rod 610. The raising and lowering is accomplished by a user with the assistance of a hand operated winch 620. The hand operated winch 620 can comprise, for example, a simple, single-geared winch system as is well known in the art. In particular, the use of such a single-geared hand operated winch system allows easy raising and lowering of the rod 610, and the teeth of the winch gear can act as a natural brake, allowing the user to easily insert a pin to hold the rod 610 in place, as explained herein.

The hitch 615 is coupled to the winch 620 by a cable 625, which could be a steel cable, heavy wire cable, or other suitable durable cable. The cable 625 is coupled through a pulley 650, which could be, for example, an enclosed pulley as is known in the art. Near the top of the rod 610 is a notched lifter 630. The notched lifter 630 can comprise, for example, a solid metal piece with a notch cut out of it. The notch is adapted to fit under a pin 640 that is inserted through a hole in the mast 560.

When an operator turns the hand operated winch 620 in a first direction, such as counterclockwise, the cable is pulled upwards which pulls the hitch 615 upwards. The hitch 615 is coupled to the rod 610, which traverses upwards vertically through a guide 605. As the rod 610 moves upward the lifter 630 is also pulled upwards. The notched lifter 630 pushes upward on the pin 640, which pulls the mast upward until the entire section of the mast 560 is deployed; i.e., entirely extended. Once a section is entirely extended, an operator can affix the section in place using a pin (not shown).

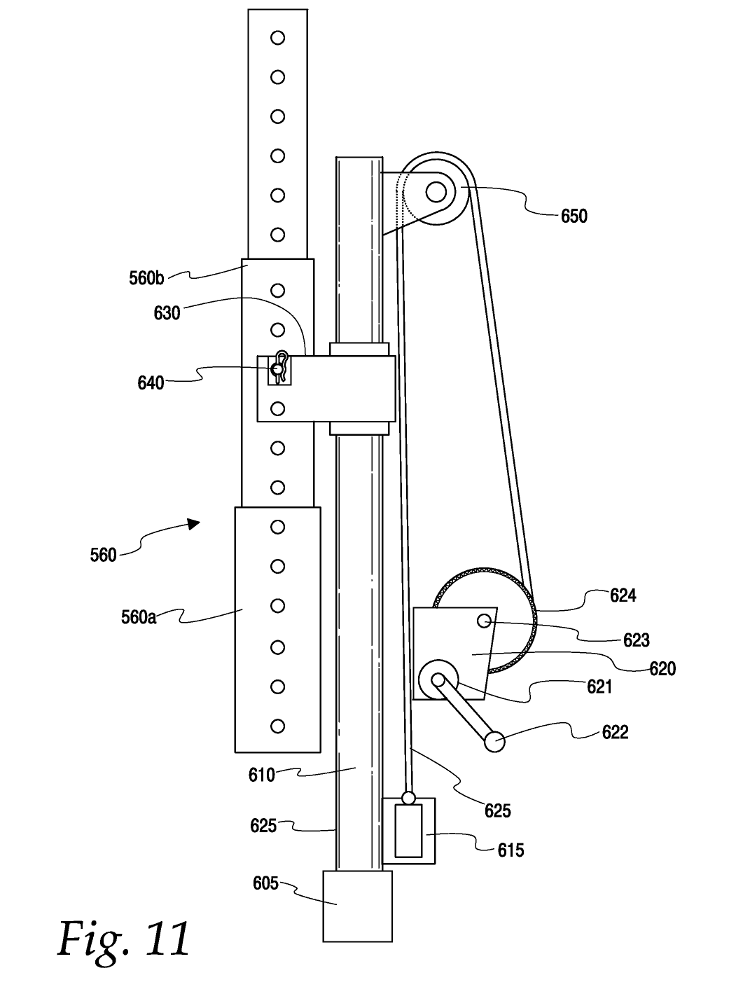

Turning to FIG. 11, a close-up view of the extending unit 600 is shown as well as two sections 560a,560b of the mast 560. It should be noted that the mast 560 can comprise more than two sections as necessary, based on the desired height of the lighting tower. As shown, the extending unit 600 includes a rod 610 that can traverse vertically up and down within a guide 605. The lower end of the rod 610 has a hitch 615 that is either integrally formed with the rod 610, or attached to the rod 610. A cable 625 is coupled to the hitch by any mean known within the prior art, such as, for example, by a loop, and is routed through a pulley 650 (generally an enclosed pulley) to a hand operated winch 620. The hand operated winch includes a spindle 623 that has a first gear 624 on the exterior of the spindle. The first gear 624 is coupled to a second gear 621; generally, the second gear 621 will be smaller and have less teeth than the first gear; for example, the gear ratio could be between 3.7:1 and 5.1:1, although higher and lower gear ratios can be used. The second gear 621 can be driven by a user operated handle 622, or, alternatively, the second gear can be coupled to a battery driven motor (not shown). A notched lifter 630 is coupled to the rod 610, and is adapted to apply upward force on a pin 640 that is placed through the mast, which can cause the mast to extend.

By turning the second gear 621 in a first direction, such as counterclockwise, using a handle 622 or otherwise, a user can cause the rod 610 to move upwards within the guide 605. As the rod 610 moves upwards the notched lifter 630 that is coupled to the rod 610 moves upwards with it. The lifter 630 applies force on pin 640 and pushes section 560b of the mast 560 upwards. Once section 560b of the mast is fully extended, the operator can insert a pin into a hole in the mast 560 just above the previous section 560a, which will hold section 560b in place. Then, if an additional section needs to be extended, the pin 640 can be moved to a hole in the new section, and the user can continue to operate the second gear 621.

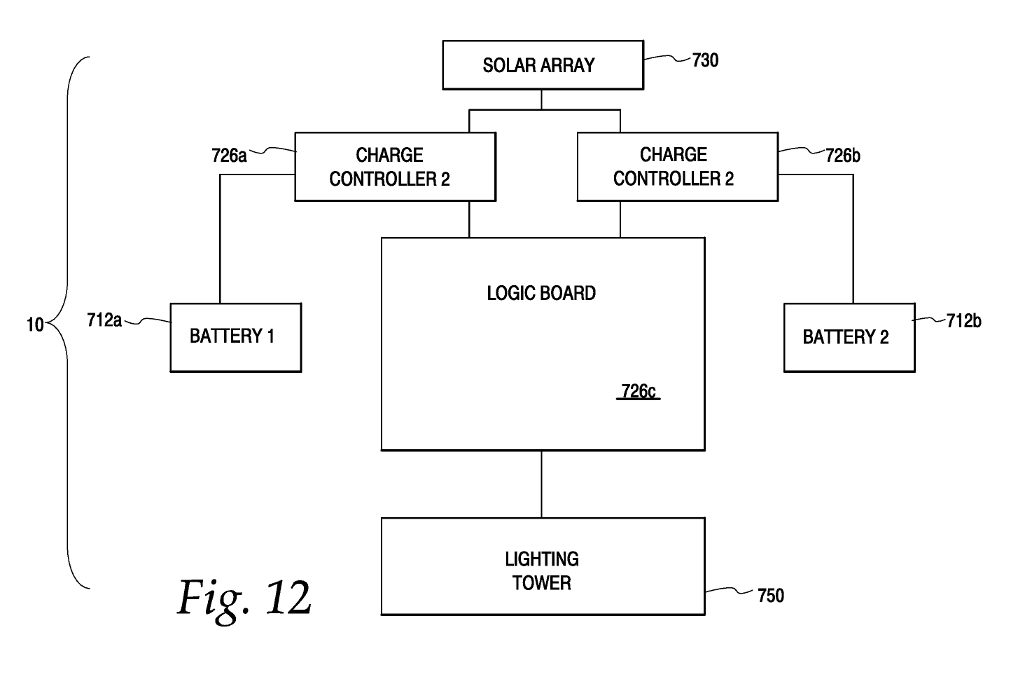

Turning to FIG. 12, a block diagram of the mobile solar power source 10 is illustrated. This figure builds on, and is a particularized application of, the system of FIG. 2. In particular, a solar array 730 is coupled to a first charge controller 726a and a second charge controller 726b. The charge controllers 726a and 726b are coupled to a logic board 726c. The first charge controller 726a is coupled to a first battery bank 712a. The second charge controller 726b is coupled to a second battery bank 712b. In addition, the mobile solar power source 10 can optionally include a lighting tower 750 coupled to the logic board 716c.

Each battery bank 712a, 712b can comprise a number of batteries with various voltage configurations and amp hour capacities. For example, each battery bank can comprise three 24 VDC (V=volts and DC=direct current) batteries each with a 400 amp hour (AH) capacity. In a separate embodiment, each battery bank can comprise four 12 VDC batteries each having a 600 AH capacity. Other combinations can be used as well. A variety of battery technologies; i.e., lead acid, lithium ion, etc., can be used as well. Generally, however, durable battery technologies are preferred.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A mobile solar power source comprising:
i) a trailer including a suspension and wheels and a base housing attached to the trailer and including a front wall, a rear wall, a first side wall, a second side wall, a roof and a floor, whereby the side walls are interconnected by the front wall and the rear wall, and the front wall, rear wall, first side wall, second side wall, roof and floor define an interior of the base housing;
ii) a first solar panel coupled to the exterior of the front wall;
iii) a second solar panel coupled to the left side of the first solar panel by a hinge, the second solar panel having a top surface, the top surface including a first integrated slot;
iv) a third solar panel coupled to the right side of the first solar panel by a hinge, the third solar panel having a top surface, the top surface including a second integrated slot;
v) the first solar panel, the second solar panel, and the third solar panel arranged to open toward a front of the housing;
vi) a battery unit comprising a first battery bank and a second battery bank;
vii) a control unit, the control unit coupled to the first solar panel, the second solar panel, and the third solar panel, and the battery unit, the control unit comprising a first charge controller coupled to the first battery bank, a second charge controller coupled to the second battery bank, and a logic board;
viii) a first brace rotatably coupled to the first side wall, the first brace having a distal end adapted to fit into the first slot; and
ix) a second brace rotatably coupled to the second side wall, the second brace having a distal end adapted to fit into the second slot.

2. The mobile solar power source of claim 1 further comprising a first cable that couples the second solar panel to the control unit and a second cable that couples the third solar panel to the control unit.

3. The mobile solar power source of claim 1 further comprising a first pin, the first pin being adapted to couple the first brace to the first slot.

4. The mobile solar power source of claim 3 further comprising a wire coupling the first pin to the first brace.

5. The mobile solar power source of claim 1 further comprising:
i) a channel formed in the exterior of the roof of the base housing;
ii) a lighting tower comprising:
1) a mast positioned within the channel and rotatably coupled to the base housing, the mast including a first section and a second section disposed within the first section and wherein the second section is adapted to extend out of the first section;
2) a lighting module including at least one lamp positioned at the top of the mast; and
iii) an extending unit adapted to extend the second section out of the first section.

6. The mobile solar power source of claim 5 further comprising:
i) a winch;
ii) a rod coupled to the winch by a durable cable;
iii) a guide coupled to the rod allowing the rod to traverse vertically;
iv) a lifter coupled to the rod and to the second section of the mast;
v) whereby the winch is adapted to be operated by a user to raise and lower the lifter.

7. The mobile solar power source of claim 6 wherein the winch comprises a spindle coupled to a first gear and a second gear coupled to a handle.

8. The mobile solar power source of claim 7 further comprising a pulley mounted near the top of the guide and a hitch mounted near the bottom of the rod and wherein the durable cable is coupled to the hitch through the pulley.

9. The mobile solar power source of claim 7 further comprising a pin coupled to the mast through an aperture formed in the mast and wherein the lifter has a notch formed in it that is adapted to couple with and apply force to the pin.

10. A control unit for use with a reliable solar powered sign system, the reliable solar powered sign system including an electric sign, a battery unit comprising a first battery bank and a second battery bank, and a solar array, the control unit comprising:
i) a first charge controller coupled to the first battery bank;
ii) a second charge controller coupled to the second battery bank;
iii) a logic board coupled to the first charge controller and the second charge controller;
iv) a timer coupled to logic board; and
v) wherein the logic board is adapted to activate the electric sign based on the timer.
